(19) United States
(12) Patent Application Publication
(10) Pub. No.: US 2026/0233430 A1
(43) Pub. Date: Aug. 13, 2026

(54) APPARATUS FOR CRACKING A GYPSUM MATRIX OF A GYPSUM-BASED PANEL

(71) Applicant: Saint-Gobain Placo, Courbevoie (FR)

(72) Inventor: Tom Rostron, Loughborough (GB)

(21) Appl. No.: 19/155,933

(22) PCT Filed: Feb. 29, 2024
(86) PCT No.: PCT/EP2024/055239

§ 371 Date: Aug. 12, 2025

(30) Foreign Application Priority Data
Mar. 23, 2023 (EP) 23305401.4

(51) Int. Cl. B28B 11/10; E04C 2/04

(52) U.S. Cl. CPC B28B 11/10; E04C 2/043

(57) ABSTRACT

Lightweight construction panels, such as plasterboard, (e.g. gypsum plasterboard) are commonly used to provide internal partitions in buildings. Due to the use of plasterboard as in internal partition, it is desirable for plasterboard to absorb and block sound energy, such that sound from one room is not easily heard in an adjacent room. It has been found that providing micro cracks in the gypsum matrix of a gypsum-based panel improves the acoustic characteristics of the panel. Apparatus (300) is provided for cracking a gypsum matrix of a gypsum-based panel (10), the apparatus (300) comprising: a roller assembly (320), the roller assembly (320) configured to receive the panel (10) at an entrance of the roller assembly (320) and convey the panel (10) from the entrance to an exit of the roller assembly (320), wherein, between the entrance and the exit, the roller assembly (320) is configured to bend the panel (10) in a first direction.

### FIELD OF THE DISCLOSURE

The present disclosure relates generally to apparatus for cracking a gypsum matrix of a gypsum-based panel and finds particular, although not exclusive, utility in providing apparatus configured to provide micro cracks in a plasterboard panel.

### BACKGROUND

Lightweight construction panels, such as plasterboard, (e.g. gypsum plasterboard) are commonly used to provide internal partitions in buildings. To provide a partition, it is typical to first construct a framework from wood, metal, or another suitable material, and affix sheets of plasterboard to the frame with screws or other fixings to provide a continuous partition surface. It is also known to affix said panels to solid walls, such as brick walls, to provide a more desirable finished surface. Said panels are typically used to construct walls and ceilings. Once the panels are affixed to the framework or wall, it is known to finish the partition by either filling the joints and screw head depressions or covering the entire panel with a finishing material, such as cement plaster or gypsum plaster. It is also known to paint such panels.

Due to the use of plasterboard as in internal partition, it is desirable for plasterboard to absorb and block sound energy, such that sound from one room is not easily heard in an adjacent room. Typically, a plasterboard with a greater density is used to provide more desirable acoustic characteristics. However, a denser panel will have a greater weight, making many aspects of working with the panel, such as lifting and securing the panel, more difficult. In addition, a denser panel will typically have a higher carbon footprint, because a denser panel will contain more material and require more energy to produce.

Aspects of the present disclosure seek to provide a system and method that alleviates these problems with prior known systems and products.

### SUMMARY

According to a first aspect of the present disclosure, there is provided apparatus for cracking a gypsum matrix of a gypsum-based panel, the apparatus comprising: an assembly, the assembly configured to receive the panel at an entrance of the assembly and convey the panel from the entrance to an exit of the assembly, wherein, between the entrance and the exit, the assembly is configured to bend the panel in a first direction.

Bending the panel may mean that the panel is deformed without breaking the panel. In particular, bending the gypsum-based panel may not break the gypsum matrix into two or more pieces.

It has been found that bending the gypsum-based panel in at least one direction provides micro cracks in the gypsum matrix of the gypsum-based panel and improves the acoustic characteristics of the panel, among other characteristics. In particular, the sound absorbing qualities of the panel are improved, specifically in the frequency regions most affected by mass such as above 400 Hz. The acoustic performance of the panels at above 1000 Hz is greatly improved. As a sound wave propagates through the panel, the sound wave will be at least partially reflected at each crack interface, thereby reducing the energy of the sound wave as it passes through the panel. Accordingly, a greater number or density of cracks may improve the sound absorbing qualities of the panel. It has been found that the present invention provides approximately 30% improvement in noise attenuation. As such, desirable soundproofing may be achieved with use of lighter weight panels.

Furthermore, it has been found that providing micro cracks in the gypsum matrix improves the flexural strength of the panel. It is widely accepted that the majority of the flexural strength of a gypsum-based panel is provided by the paper facing. Typically, when a traditional panel is bent, the gypsum matrix deforms elastically over a small distance and the tensile forces are concentrated in a small area of the paper facing, resulting in tearing and failure of the panel. However, the micro cracks provided by the present invention are thought to remove most or all of the elastic deformability of the gypsum matrix and distribute tensile forces over a greater area of the paper facing. As such, a panel with a micro cracked gypsum matrix has a greater tensile strength than a panel without said micro cracks. In one flexural strength test, control plasterboard samples were found to have an average maximum load of 491.8 N. Identical plasterboard samples were subjected to bending in four directions with the apparatus described herein, and were found to have an average maximum load of 507.1 N, an approximately 3.3% increase in flexural strength. A 2.7% to 4.4% improvement in flexural strength has been observed across several flexural strength tests. To obtain the flexural strength results, samples of each plasterboard measuring 400 mm by 300 mm were cut and conditioned to a constant weight at 40° C. A load was then applied with a flexural strength testing machine, of those well known in the art, at a rate of 250 N/min. The peak load at the point of failure of the plasterboard samples was recorded. The assembly may be further configured to bend the panel in a second direction different to the first direction. In this way, a greater number of micro cracks may be provided, and/or a more desirable distribution and alignment of micro cracks may be provided.

The assembly may comprise a roller assembly. The roller assembly may comprise one or more rollers. The roller assembly may be configured to carry out one or each of the functions described with relation to the assembly herein. In a preferred embodiment, one or more of the rollers of the roller assembly is powered. The roller assembly may be arranged such that a longitudinal axis of the panel is parallel to, or perpendicular to, rotational axes of the rollers as the panel passes from the entrance to the exit of the assembly. In this way, the panel may pass through the rollers in a forward direction, along a path parallel to the longitudinal axis of the panel, or in a sideward direction, along a path perpendicular to the longitudinal axis of the panel.

Alternatively or additionally, the apparatus may comprise a series of suction cups configured to lift and deform the panel to impart the bends; a series of pairs of wheels, such as three pairs of wheels, arranged to be raised and lowered to maintain a single radius across the width of the panel; a press, for example comprising a set of rollers on individual pneumatic cylinders, arranged to press the panel against a curved form work; a pallet press configured to lift a panel, or a plurality of stacked panels, from a single point or along an axis, for example in the centre, against counter points, for example fixed members arranged at either end of the panel, to form the desired radius or curvature in the panel; and/or a pair of nip rollers or clamp configured to hold and retain an end of the panel, the nip rollers or clamp configured to accelerate in an oscillating manner, for example through mounting on and operation of pneumatic cylinders or other similar devices, to induce a wave pattern in the panel.

The apparatus may be a breaker roller. A breaker roller may be a piece of production machinery configured to impart a force on a panel with one or more rollers and the panel passes through the breaker roller. The apparatus may be arranged to operate as part of a continuous process. As such, an entrance to the apparatus or a component of the apparatus may be aligned with an exit of a preceding piece of production machinery, and an exit of the apparatus or a component of the apparatus may be aligned with an entrance of a following piece of production machinery. Alternatively, panels may be fed into, and removed from, the apparatus in a non-continuous process.

The gypsum-based panel may be plasterboard, drywall, sheetrock, gyp board, wallboard or any other known construction panel with a gypsum matrix or core. The panel may comprise a gypsum matrix between paper facing sheets. The panel may be fully dried and/or cured before being passed through the apparatus.

Cracking the gypsum matrix may mean imparting a plurality of cracks in the gypsum matrix. The cracks may provide a series of gypsum-air interfaces within the gypsum matrix. Sound waves propagating through the gypsum matrix may reflect at the gypsum-air interfaces, such that the cracked gypsum matrix absorbs, reflects or otherwise dampens the sound waves.

Accordingly, sound waves are dampened by a gypsum matrix with a relatively high number of cracks to a greater extent than a gypsum matrix with a relatively low number of cracks. It has been found through study that there are a number of effects on the physical and mechanical properties of a panel, with the effects being influenced by the severity of the radius applied. Too great a radius allows the panel to flex within the elastic phase of the panel, which causes no cracks and no change to the acoustic properties. Too small a radius causes relatively large cracks and damage to the paper and paper core interface resulting in premature flexural strength failure. However, this damage does result in an uplift in the acoustic performance. In an intermediate range of radii, between said too great a radius and too small a radius, relatively small cracks are formed across the width and to a varying extent across the thickness of the panel perpendicular to the direction the bend has been applied. There is a difference in the morphology of the cracks at the surfaces of the panel depending on whether the particular side of the panel was exposed to tensile or compressive forces during bending. Via this mechanism, panels bent concave and convex in the same direction achieve better acoustic results, as each side is subjected to both tensile and compressive forces.

The entrance of the assembly may be the region of the assembly into which a panel may be fed or otherwise inserted. As such, the entrance may be a receiving portion configured to receive a panel. The exit of the assembly may be the region of the assembly from which the panel is taken or otherwise retrieved. The assembly being configured to convey the panel from the entrance to an exit of the assembly may mean that the assembly is configured to allow the panel to pass through, on, over or otherwise past the assembly. The assembly may be configured to support the panel as it is conveyed from the entrance to the exit to prevent damage to the panel. The assembly may be configured to move or urge the panel from the entrance to the exit, for example with one or more powered components such as rollers as discussed herein.

The assembly being configured to bend the panel in the first and second directions between the entrance and the exit may mean that the panel does not follow a singular planar path between the entrance and the exit. For example, the panel may be moved along one or more curved planes, moved between at least two non-parallel planes through a radius, or a combination thereof.

The assembly may be configured to bend a first portion of the panel in the first direction and bend a second portion of the panel in the second direction. In this way, different crack characteristics may be applied to the first and second portions. The first direction may be opposite to the second direction. For example, the first direction and the second direction may be opposed directions about the same axis. Alternatively, the first direction and the second direction may be bending directions about different axes. For example, the first direction may be a bend about an x-axis, and the second direction may be a bend about a y-axis, wherein the x-axis and the y-axis are perpendicular axes. The x-axis may be a width wise axis of the panel and the y-axis may be a lengthwise axis of the panel. Other bending orientations are envisaged.

The assembly may be configured to, subsequently to bending the first portion in the first direction and bending the second portion in the second direction, bend the first portion in the second direction and bend the second portion in the first direction. In this way, the first portion and the second portion may be bent in both the first and the second directions. As such, both the first portion and the second portion may have the same or substantially the same crack characteristics, which may be a combination of the crack characteristics imparted by the bends in the first and second directions.

The roller assembly may include a first set of rollers configured to bend the first portion in the first direction and bend the second portion in the second direction. The roller assembly may include a second set of rollers configured to bend the first portion in the second direction and bend the second portion in the first direction. The first and second set of rollers may each comprise a plurality of rollers, wherein at least one of the plurality of rollers is configured to bend the panel portion in the first direction and at least another one of the plurality of rollers is configured to bend the panel portion in the second direction. Alternatively, the first and second set of rollers may each comprise one or more rollers having non-constant radius, as described herein, to bend in the first and second directions simultaneously. The roller assembly may be configured to convey the panel from the first set of rollers to the second set of rollers as the panel is conveyed from the entrance of the roller assembly to the exit of the roller assembly.

The assembly may be configured to bend the first portion of the panel in the first direction and bend the second portion of the panel in the second direction simultaneously. The assembly may be configured to bend the first portion of the panel in the second direction and bend the second portion of the panel in the first direction simultaneously. In this way, an overall length, footprint and/or size of the apparatus may be reduced.

To bend the first and second portions in different directions simultaneously, the roller assembly may comprise either: two sets of rollers configured to bend the panel in different directions; or at least one set of rollers with non-constant radius along a length of the rollers. Alternatively, or additionally, one or more rollers of the roller assembly may have a non-constant radius and be offset to a second roller of the roller assembly, to impart a length wise directional bend to the panel along with a width wise directional bend to the panel. A relatively close proximity of subsequent pairs of rollers may additionally contribute to this effect. The two sets of rollers may be arranged proximate to one another such that the first portion of the panel is between the first set of rollers whilst the second set of rollers is between the second set of rollers. The first set of rollers may be spaced from the second set of rollers by a distance of 100 mm to 600 mm, 150 mm to 400 mm, 200 mm to 300 mm, preferably by 240 mm. As such, the pitch of the rollers may be 240 mm. In this way, a panel with a length of at least 240 mm may be arranged between the first set of rollers and the second set of rollers simultaneously. Should the first set of rollers be spaced from the second set of rollers by more than 300 mm, 400 mm, 500 mm, or 600 mm, the roller assembly may comprise at least one support roller, preferably a pair of opposed support rollers, positioned between the first set of rollers and the second set of rollers.

Alternatively, the assembly may be configured to bend the panel in the second direction subsequently to bending the panel in the first direction. The assembly may therefore be configured to bend the panel in only a single direction at any given time.

A minimum radius of curvature applied to the panel may be in the range 2000 mm to 1000 mm, 1800 mm to 1000 mm, 1700 mm to 1000 mm, 1500 mm to 1000 mm, or 1250 mm to 1000 mm. It has been found that 12.5 mm thickness gypsum wallboards typically break when bent with a radius of curvature less than 1000 mm. Gypsum wallboards with thicknesses between 10 mm and 25 mm also typically break when bent with such a radius of curvature. In this way, the gypsum matrix of the panel may be cracked without breaking the board. For example, with a panel having a gypsum matrix between paper facing sheets, the gypsum matrix may be cracked without tearing or otherwise damaging the paper facing sheets. The bending may cause micro cracks within the gypsum matrix, which have been found to improve the acoustic characteristics of a gypsum-based panel. The assembly may be configured to bend the panel such that the paper facing sheets are elastically deformed, without plastic deformation or tearing. In this way, the paper sheets may be unaffected by the bending of the boards. Visible and/or mechanical degradation of the paper facing sheets is undesirable. A maximum radius of curvature applied to the panel may be in the range 6000 mm to 2000 mm, 5000 mm to 2500 mm, 4500 mm to 3000 mm, or 4000 mm to 3500 mm. A bend with a maximum radius as disclosed herein may be necessary for micro cracks to form in the gypsum matrix. It can be seen, therefore, that the bend applied by the apparatus may have a radius of curvature within a range with end values taken from any of the minimum and maximum values, or end values for ranges of minimum and maximum values, disclosed herein.

The roller assembly may comprise at least one pair of opposed rollers configured to receive the panel therebetween. The at least one pair of opposed rollers may include a first roller and a second roller spaced from the first roller. The first roller may be spaced from the second roller by a distance of at least 10 mm, 13 mm or 15.5 mm. In this way, a panel with a thickness of 9.5 mm, 12.5 mm, or 15 mm may pass through the first and second rollers with a clearance of 0.5 mm. A clearance may be necessary to prevent pinching or crushing of the panel by the rollers. Any suitable or desired spacing may be provided. The distance between the first and second rollers may be dependent on the thickness of the panel intended to be bent by the apparatus. The distance between the first roller and the second roller may be adjustable. In this way, the apparatus may be suitable for use with a range of panels having different thicknesses. The distance between the first roller and the second roller may be adjustable between a range of predetermined positions, such as 10 mm, 13 mm and 15.5 mm. In this way, the distance between the rollers may be accurately and/or precisely adjusted between a plurality of preferable or desired predetermined distances. As such, the apparatus may be suitable for use in the manufacture of panels having different thicknesses. For example, the apparatus may first be used to manufacture panels with a thickness of 12.5 mm, before being adjusted and used to manufacture panels with a thickness of 15 mm.

Each roller may have a smooth surface. In this way, no imprints, ridges or other undesirable surface markings may be applied to the panel. Surface markings may reduce the flexural strength of the panel and be aesthetically undesirable.

The roller assembly may further comprise drive means configured to rotate the first roller and/or the second roller. In some circumstances and arrangements, the panel may not be able to pass through the rollers unless one or more of the rollers are driven to rotate. By driving one or more of the rollers, the panel may be conveyed from the entrance of the roller assembly to the exit of the roller assembly by the driven rollers. Each of the rollers may be driven to rotate. The roller assembly may comprise a motor, a linkage, a transmission, a power source, a controller and/or any other component required to rotate the roller or rollers. The first roller and the second roller may each have a non-constant radius along a length of said roller. The first roller and the second roller may each include an enlarged region with a relatively large radius and a narrowed region with a relatively small radius. The enlarged region may smoothly transition into the narrowed region, without a step change in radius along a length of the roller. Unsmooth transitions, such as a step change, may results in an edge that may leave an imprint or otherwise damage the surface of the panel. Alternatively, the enlarged region and the narrowed region may be separated by a region with no roller. Alternatively, the enlarged region and the narrowed region may be separated by a step change in the radius. The enlarged and narrowed regions may have a smooth waveform profile. A smooth waveform may be any waveform without a step change in amplitude. The waveform may have a repeating wave, unit or section. The enlarged and narrowed regions may be sinusoidal regions or otherwise curved. The first and second rollers may be mutually arranged such that: the enlarged region of the first roller is adjacent to the narrowed region of the second roller; and the enlarged region of the second roller is adjacent to the narrowed region of the first roller. The first and second rollers may be mutually arranged such that a constant width gap is provided between the first and second rollers.

The first roller and the second roller may have a smooth waveform profile, such as a sinusoidal profile, along a length of the roller. The rollers may be arranged to have at least one full sinusoidal period, or other waveform period, along a length of the roller. As such, a radius of the roller may increase and then decrease, or decrease and then increase, along a length of the roller. The roller may comprise a first roller portion and a second roller portion, wherein the roller portions have different radii, curvatures or other surface profiles. The rollers may have a continuous waveform pattern. In this way, the angle or way in which the panel is presented to the rollers is not relevant. The waveform may have a period of between 400 mm and 1200 mm, 500 mm and 1100 mm, 600 mm and 1000 mm, or 700 mm and 900 mm, preferably 800 mm. The waveform may comprise at least one curved peak section, at least one curved trough section, and at least one approximately linear section.

An approximately linear section may be arranged between each peak section and each trough section. Accordingly, the waveform may comprise a profile, viewed along a longitudinal axis of the roller, including a trough section, an approximately linear section, and a peak section. The peak section may be followed by another approximately linear section. Further trough sections, approximately linear sections, and peak sections may follow along the longitudinal length of the roller. Each trough section, approximately linear section, and/or peak section may extend along the longitudinal axis of the roller by a distance of between 100 mm and 300 mm, 125 mm and 275 mm, 150 mm and 250 mm, or 175 mm and 225 mm, preferably 200 mm.

The waveform may be arranged such that a bend with a preferred radius of curvature is applied to the panel. The preferred radius of curvature may be in the range of 1000 mm to 3500 mm, 1500 mm to 2750 mm, 2000 mm to 2500 mm, or 2100 mm to 2400 mm, preferably 2250 mm. The waveform may have an amplitude in the range 2 mm to 6 mm, 2.5 mm to 5.5 mm, 3 mm to 5.25 mm, 4 mm to 5 mm, or 4.25 mm to 4.75 mm, preferably approximately 4.5 mm. Arranging the rollers with a gap therebetween as discussed herein may result in the panel being bent into a waveform shape with a smaller amplitude than that of the rollers. The amplitude of the panel waveform may be approximately 0.5 mm less than the amplitude of the roller waveform.

The roller assembly may comprise two or more pairs of opposed rollers. The opposed rollers may have any of the characteristics described herein. In one embodiment, the roller assembly includes four pairs of rollers each having non-constant radii as described herein.

The four pairs of rollers may be arranged such that, when a panel is passed through the roller assembly, a portion of the panel is bent in a first direction by a first set of rollers, a second direction opposite the first direction by a second set of rollers, a third direction different to the first and second directions by a third set of rollers, and a fourth direction opposite the third direction by a fourth set of rollers. The first direction may be a positive bend about a first axis, the second direction may be negative bend about the first axis, the third direction may be a positive bend about a second axis, and the fourth direction may be a negative bend about the second axis. The first and second axes may be perpendicular. The axes may be parallel to a plane of the panel. Alternatively, the axes may not be parallel to the plane of the panel. The bends in the first, second, third and fourth directions may be carried out in any order.

In some circumstances, it may not be possible to provide a sufficient bend to edge regions of a panel to provide the micro cracks in the edge regions. However, the edge regions will typically be secured to a support, such as a wooden stud, which provides additional acoustic dampening in the edge regions of the panels.

The apparatus may be positionable, in use, in line with existing production equipment. The apparatus may be arranged such that the entrance to the assembly is in line with an exit of a preceding production machine. Preferably, the apparatus is arranged such that a first roller of a pair of opposed rollers is moveable relative to a second roller of the pair of opposed rollers, such that a distance between the first roller and the second roller is adjustable. In this way, the apparatus may be reconfigured to accept panels having different thicknesses, or arranged in a bypass configuration wherein the opposed rollers are spaced to such an extent that the rollers impart no bend on the panel. In the bypass configuration, the opposed rollers may be spaced by at least 400 mm, 500 mm, 600 mm, or any other suitable distance. In the bypass configuration, one or more of the rollers may support a panel passing through the apparatus.

Alternatively, or additionally, the assembly may be supported by an adjustable base. The adjustable base may be moveable between an extended position, in which the entrance to the assembly is in line with the exit of the preceding production machine, and a retracted position, in which the entrance to the assembly is spaced from and below the exit of the preceding production machine. Alternatively, with the base in the retracted position, the entrance to the assembly may be in line with the exit of the preceding production machine, and with the base in the extended position, the entrance to the assembly may be spaced from and above the exit of the preceding production machine. In this way, the apparatus can be removed from the production line by retracting or extending the base, respectively. An upper surface of the roller breaker may comprise support rollers configured to support the panels as they pass over the top of the apparatus. The base may comprise a hydraulic ram, a pneumatic ram, an electromechanical device and/or any other known actuator configured to move the base between the retracted and the extended positions.

According to a second aspect, there is provided a method of improving an acoustic characteristic of a gypsum-based panel, the method comprising: providing a gypsum-based panel with a gypsum matrix; and bending the panel in a first direction to crack the gypsum matrix.

The method may further comprise bending the panel in a second direction, different to the first direction, to crack the gypsum matrix.

The gypsum-based panel may comprise at least one paper face, preferably two paper faces. The cracking of the gypsum matrix may be conducted without tearing the paper face or paper faces.

The method may be carried out with the apparatus of the first aspect. It will be understood that various additional method steps may be carried out with one or more of the optional features of the first aspect disclosed herein.

### BRIEF DESCRIPTION OF THE DRAWINGS

The disclosure will be further described with reference to examples depicted in the accompanying figures in which:

FIG. 1 is a schematic view of a pair of rollers having a smooth waveform profile;

FIG. 2 is a schematic view of a roller assembly including four pairs of rollers;

FIG. 3A is a schematic side view of apparatus for cracking a gypsum matrix of a gypsum-based panel with an adjustable base in an extended position;

FIG. 3B is a schematic side view of the apparatus of FIG. 3 with the base in a retracted position;

FIG. 4 is an example graph showing the amplitude of a portion of the waveform of a roller against the longitudinal length of the roller; and

FIG. 5 is a graph showing the improvement in acoustic performance due to the number of bends made to a 12.5 mm thick plasterboard panel.

### DETAILED DESCRIPTION

The following description presents particular examples and, together with the drawings, serves to explain principles of the disclosure. However, the scope of the invention is not intended to be limited to the precise details of the examples, since variations will be apparent to a skilled person and are deemed to be covered by the description. Terms for components used herein should be given a broad interpretation that also encompasses equivalent functions and features. In some cases, alternative terms for structural features may be provided but such terms are not intended to be exhaustive.

Descriptive terms should also be given the broadest possible interpretation; e.g. the term “comprising” as used in this specification means “consisting at least in part of” such that interpreting each statement in this specification that includes the term “comprising”, features other than that or those prefaced by the term may also be present. Related terms such as “comprise” and “comprises” are to be interpreted in the same manner. Directional terms such as “vertical”, “horizontal”, “up”, “down”, “top”, “bottom”, “upper” and “lower” are used for convenience of explanation usually with reference to the illustrations and are not intended to be ultimately limiting if an equivalent function can be achieved with an alternative dimension, orientation and/or direction.

The description herein refers to examples with particular combinations of features, however, it is envisaged that further combinations and cross-combinations of compatible features between embodiments will be possible. Indeed, isolated features may function independently as an invention from other features and not necessarily require implementation as a complete combination.

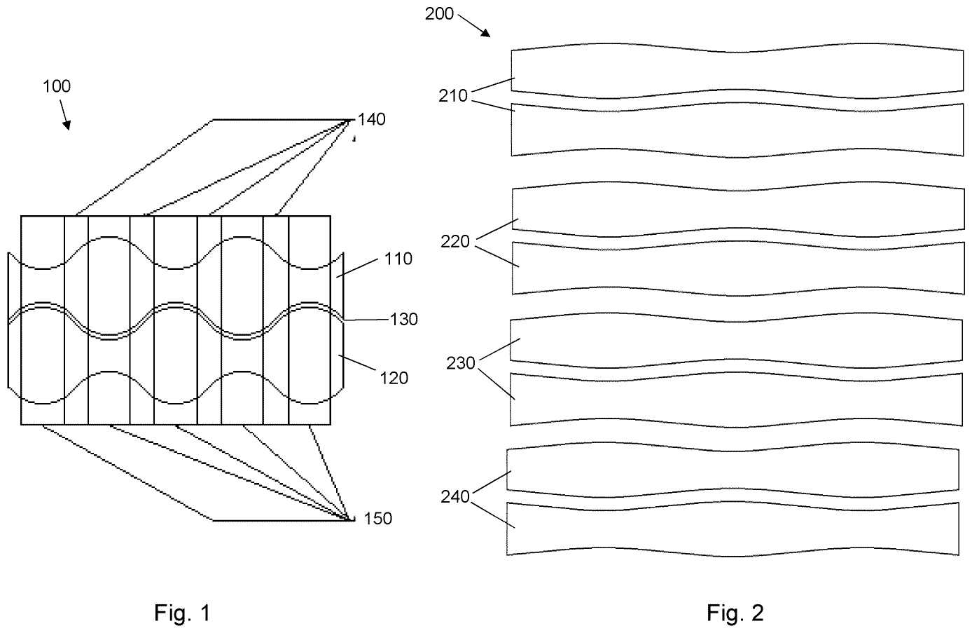

FIG. 1 is a schematic view of a pair of rollers 100 having a smooth waveform profile. The pair of rollers 100 includes a first roller 110 and a second roller 120 mutually arranged such that a gap 130 is provided therebetween. The first roller 110 and the second roller 120 have the same period and amplitude but are offset by half a period along the length of the rollers 110, 120. As such, the troughs of the first roller 110 are aligned with the peaks of the second roller 120, and the peaks of the first roller 110 are aligned with the troughs of the second roller 120. As the first roller 110 and the second roller 120 have the same waveform surface profile, and are offset by half a period, the gap 130 therebetween has a constant width along the length of the rollers 110, 120. The gap 130 is sized dependent on the thickness of plasterboard to be bent by the pair of rollers 100. The gap 130 is arranged to be larger than the thickness of the plasterboard such that the plasterboard is not crushed, nipped or otherwise damaged.

Due to the waveform profile and arrangement of the first roller 110 and the second roller 120, there are areas of the rollers 110, 120 where no effective radius is applied 140 and areas of the rollers 110, 120 where an effective radius is applied 150. As shown in FIG. 1, the areas where no effective radius is applied 140 can be considered approximately to have no curvature, and hence no effective radius. Accordingly, approximately no bend is applied to the plasterboard portions that pass through the rollers 110, 120 adjacent to the areas where no effective radius is applied 140. To the contrary, the areas where an effective radius is applied 150 are shown to have a relatively significant curvature such that a bend is applied to the plasterboard portions that pass through the rollers 110, 120 adjacent to the areas where an effective radius is applied 150.

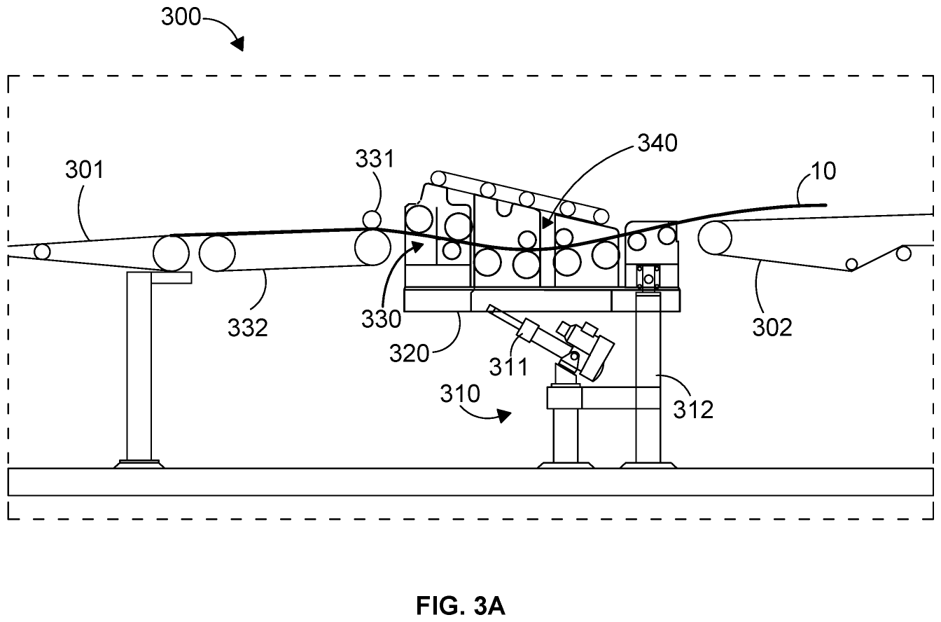

FIG. 2 is a schematic view of a roller assembly 200 including four pairs of rollers 210, 220, 230, 240. Each pair of rollers 210, 220, 230, 240 may be generally similar to the pair of rollers 100 shown in in FIG. 1. The four pairs of rollers 210, 220, 230, 240 are arranged sequentially such that a plasterboard may pass from a first pair of rollers 210, to a second pair of rollers 220, to a third pair of rollers 230, and finally to a fourth pair of rollers 240. The four pairs of rollers 210, 220, 230, 240 have generally the same waveform profile, having the same period and amplitude, but are offset along a lengthwise direction of the rollers such that each portion of a plasterboard passing through the four pairs of rollers 210, 220, 230, 240 is presented with a different bend angle and/or direction by each of the four pairs of rollers 210, 220, 230, 240. Accordingly, the portions of a plasterboard passed through the first pair of rollers 210 that have no effective radius, and therefore no bend applied, may pass through an area of one or more of the other pairs of rollers 220, 230, 240 that do have an effective radius and apply a bend. As such, each portion of the plasterboard may be bent by one or more of the pairs of rollers 210, 220, 230, 240, preferably at least two of the pairs of rollers 210, 220, 230, 240. Furthermore, each portion of a plasterboard passed through the roller assembly 200 may be bent in four directions. In some circumstances, edge portions of the plasterboard may not be bent or bendable.

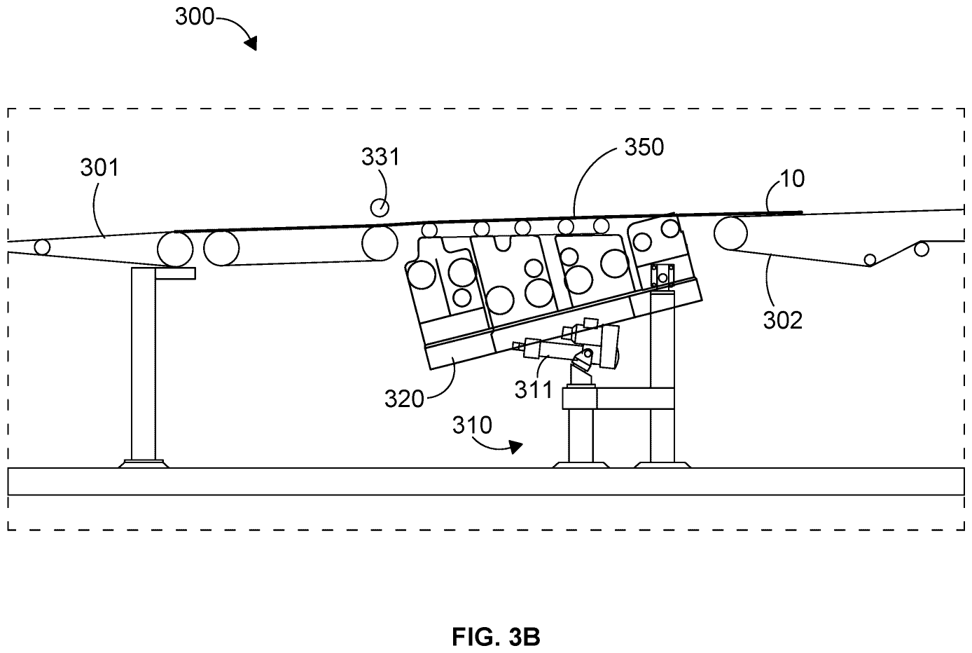

FIG. 3A is a schematic side view of apparatus 300 for cracking a gypsum matrix of a gypsum-based panel with an adjustable base 310 in an extended position. The apparatus 300 is arranged between a preceding conveyor 301 and a following conveyor 302. The apparatus 300 includes a roller assembly 320 configured to receive a plasterboard 10 from the preceding conveyor 301, bend the plasterboard 10 in two directions, and pass the plasterboard 10 to the following conveyor 302. The roller assembly 320 incudes a first set of rollers 330 configured to bend the plasterboard 10 in a downward direction with an effective radius of 2250 mm. A guide roller 331 is provided to support a top surface of the plasterboard 10 as it is bent downwards by the first set of rollers 330 and to prevent lifting of the plasterboard 10 off of a feed conveyor 332.

Following the first set of rollers 330, the roller assembly 320 incudes a second set of rollers 340 configured to bend the plasterboard 10 in an upward direction with an effective radius of 2250 mm. Accordingly, a plasterboard 10 passing through the roller assembly 320 is bent in both a downward and then an upward direction. The plasterboard 10 leaves the roller assembly 320 and is moved onward by the following conveyor 302.

The base 310 is floor mounted and includes a hydraulic ram 311 moveable between an extended position, as shown in FIG. 3A, and a retracted position, as shown in FIG. 3B. The roller assembly 320 is rotationally attached to the hydraulic ram 311 and a fixed frame 312 of the base 310. The hydraulic ram 311 is also rotationally attached to the fixed frame 312 at an end opposite to the end attached to the roller assembly 320. With the hydraulic ram 311 in the extended position, the roller assembly 320 is positioned such that a plasterboard 10 leaving the preceding conveyor 301 is received by the first set of rollers 330 of the roller assembly 320 and the plasterboard 10 is bent accordingly. Alternatively or additionally, the base 310 may comprise other apparatus for moving the roller assembly 320, such as a pneumatic ram or other pneumatic device, or an electromechanical device such as a worm drive.

FIG. 3B is a schematic side view of the apparatus 300 of FIG. 3 with the base 310 in a retracted position. Accordingly, the hydraulic ram 311 is in the retracted position. With the hydraulic ram 311 shortened, the roller assembly 320 has pivoted down below the conveyor line between the preceding conveyor 301 and following conveyor 302. The roller assembly 320 includes a series of support rollers 350 on an upper surface thereof. With the base 310 in the retracted position, the support rollers 350 are aligned with the preceding conveyor 301 and the following conveyor 302 such that a plasterboard 10 may pass from the preceding conveyor 301, over the support rollers 350 and to the following conveyor 302 without being bent. Therefore, the apparatus 300 may be moved between an operational position, as shown in FIG. 3A, and a non-operational position, as shown in FIG. 3B, without needing to remove and/or replace the apparatus 300 in the production line.

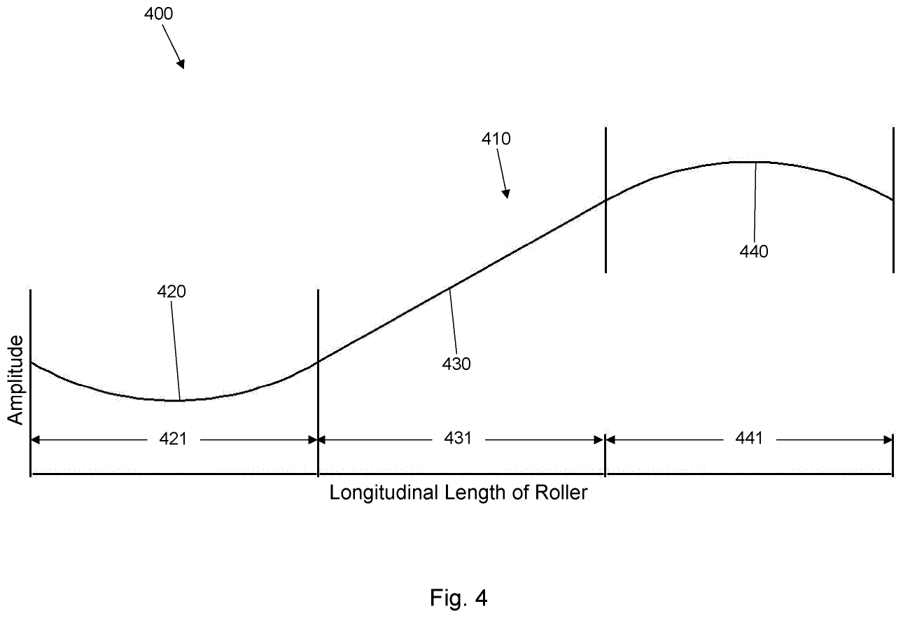

FIG. 4 is an example graph 400 showing the amplitude of a portion of the waveform 410 of a roller against the longitudinal length of the roller. The waveform includes a trough portion 420, an approximately linear portion 430 and a peak portion 440. The approximately linear portion 430 is positioned between the trough portion 420 and the peak portion 440 and connects the trough portion 420 to the peak portion 440 without a step change in amplitude. Although not shown, the peak portion 440 may be followed by another approximately linear portion, with a gradient opposite to the approximately linear portion 430 shown in FIG. 4. The waveform 410 may repeat continuously along the longitudinal length of the roller. Alternatively, one or more breaks or gaps may be provided between the waveform sections.

As shown in FIG. 4, the waveform 410 is smooth without step changes in amplitude. The trough portion 420 has a longitudinal length 421 that is equal to a longitudinal length 431 of the approximately linear portion 430, and that is equal to a longitudinal length 441 of the peak portion 440. The longitudinal length 421, 431, 441 of each portion 420, 430, 440 may be between 100 mm and 300 mm, 125 mm and 275 mm, 150 mm and 250 mm, or 175 mm and 225 mm, preferably 200 mm.

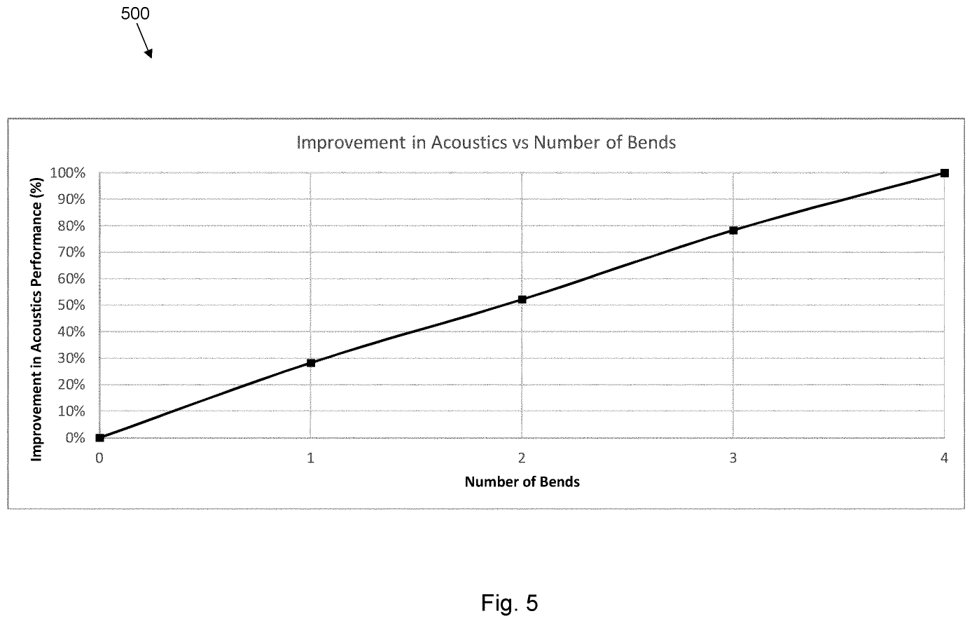

FIG. 5 is a graph 500 showing the improvement in acoustic performance due to the number of bends made to a 12.5 mm thick plasterboard panel. A control plasterboard and four sample plasterboards, each 12.5 mm thick, were tested. The control plasterboard was not bent and is representative of the prior known products. A first sample plasterboard was bent in a single direction with a radius of curvature of 2250 mm. The bend in a single direction was a bend about an axis perpendicular to a length of the plasterboard. Additional test carried out with a single bend about an axis parallel to a length of the plasterboard gave similar results to the test carried out with a single bend about an axis perpendicular to a length of the plasterboard. As such, it may be concluded that the direction of the bend, if only a single bend it made, is not relevant. A second sample plasterboard was bent in two directions, each bend with a radius of curvature of 2250 mm. The first of the two directions was a bend about an axis perpendicular to a length of the plasterboard, as with the plasterboard bent in a single direction. The second of the two bends was a bend about an axis perpendicular to a length of the plasterboard in the opposite rotational orientation to the first bend. As such, the plasterboard was bent in two directions about the same axis, in the x direction. In other words, the second sample plasterboard was bent back and forth about the same axis. A third sample plasterboard was bent in three directions, each bend with a radius of curvature of 2250 mm. The three directions include the two bend directions previously described with respect to the second sample plasterboard bent in two directions, plus a bend in a third direction. The bend in a third direction was a bend about an axis parallel to a length of the plasterboard. A fourth sample was bent in four directions, each bend with a radius of curvature of 2250 mm. The four directions include each of the three directions described with respect to the plasterboard bent in three directions, plus a bend in a fourth direction. The fourth bend is a bend about an axis parallel to the length of the plasterboard in the opposite direction to the third bend. As such, the four bends may be considered to be positive and negative bends in the x and y directions of the plasterboard.

In other words, the fourth sample plasterboard was bent back and forth about the two axes. The acoustic performance of the plasterboards was analysed with Resonance Frequency Damping Analysis (RFDA). In the RFDA, samples of the plasterboard were cut to a size of 200 mm by 70 mm, with the greater dimension orientated along a direction of the or a bend imparted on the board. The samples were then conditioned for a minimum of 24 hours at 23° C. and 50% relative humidity. Sample dimensions and weight were then verified to ensure consistency. The RFDA was carried out using an imce RE.TE.19.50.0020.01. Vibrations were recorded using a microphone and analysed at the moment of excitation of the sample. The resultant analysis gives a reading of Dynamic Young's modulus and damping.

As shown in the graph 500, the first sample plasterboard bent in a single direction had an approximately 28% increase in acoustic performance, when compared to the control plasterboard that was not bent. The second sample plasterboard bent in two directions had an approximately 52% increase in acoustic performance, when compared to the control plasterboard that was not bent. The third sample plasterboard bent in three directions had an approximately 78% increase in acoustic performance, when compared to the control plasterboard that was not bent. The fourth sample plasterboard bent in four directions had an approximately 100% increase in acoustic performance, when compared to the control plasterboard that was not bent. As such, it is clear that bending the plasterboard, which provides micro cracks in the gypsum matrix of the plasterboard, improves the acoustic performance of the plasterboard significantly. A generally linear relationship between the number of bends and the acoustic performance improvement was observed.

A further experiment, with similar methodology to that described with reference to FIG. 5, was carried out on 15 mm thick plasterboard samples. Control samples were prepared and not bent, and are therefore representative of the prior known products. A first sample plasterboard was bent in four directions in the same manner as the fourth sample plasterboard discussed with reference to FIG. 4, with a radius of curvature of 2250 mm.

RFDA was carried out as described herein to obtain a reading of Dynamic Young's modulus and damping for the control plasterboard and the first sample plasterboard. In the RFDA, several test samples of the first sample plasterboard, at a size of 200 mm by 70 mm, were taken. Some test samples were taken with the 200 mm dimension oriented along a length of the first sample plasterboard, and some test samples were taken with the 200 mm dimension oriented along a width of the plasterboard. It has been found that RFDA samples are sensitive to the orientation at which the sample is cut from the plasterboard, relative to the direction or directions in which the plasterboard is bent. The test samples with the 200 mm dimension oriented along a length of the plasterboard had an approximately 34% increase in acoustic performance, when compared to the control plasterboard. The test samples with the 200 mm dimension oriented along a width of the plasterboard had an approximately 55% increase in acoustic performance, when compared to the control plasterboard. It may also be concluded that the increase in acoustic performance, imparted by bending the plasterboard, is more pronounced in thicker plasterboard, owing to the greater size of the gypsum matrix.

1. An apparatus for cracking a gypsum matrix of a gypsum-based panel, the apparatus comprising:
an assembly, the assembly configured to receive the panel at an entrance of the assembly and convey the panel from the entrance to an exit of the assembly, wherein, between the entrance and the exit, the assembly is configured to bend the panel in a first direction,
wherein the assembly comprises a roller assembly,
and the roller assembly comprises at least one pair of opposed rollers configured to receive the panel therebetween, the at least one pair of opposed rollers including a first roller and a second roller spaced from the first roller, and
wherein the first roller and the second roller each have a non-constant radius along a length of said roller.

2. The apparatus of claim 1, wherein the assembly is further configured to bend the panel in a second direction different to the first direction.

3. The apparatus of claim 2, wherein the assembly is configured to bend a first portion of the panel in the first direction and bend a second portion of the panel in the second direction.

4. The apparatus of claim 2, wherein the assembly is configured to bend the first portion of the panel in the first direction and bend the second portion of the panel in the second direction simultaneously.

5. The apparatus of claim 1, wherein a minimum radius of curvature applied to the panel is 1000 mm and a maximum radius of curvature applied to the panel is 4500 mm.

6. The apparatus of claim 1, wherein the roller assembly further comprises drive means configured to rotate the first roller and/or the second roller.

7. The apparatus of claim 1, wherein the first roller is spaced from the second roller by a distance of at least 10 mm.

8. The apparatus of claim 1, wherein the first roller and the second roller each include an enlarged region with a relatively large radius and a narrowed region with a relatively small radius, and the first and second rollers are mutually arranged such that:
the enlarged region of the first roller is adjacent to the narrowed region of the second roller; and
the enlarged region of the second roller is adjacent to the narrowed region of the first roller.

9. The apparatus of claim 8, wherein the first roller and the second roller each have a smooth waveform profile.

10. The apparatus of claim 1, wherein the roller assembly comprises two or more pairs of opposed rollers.

11. The apparatus of claim 1, wherein first roller is moveable relative to the second roller such that a distance between the first roller and the second roller is adjustable.

12. A method of improving an acoustic characteristic of a gypsum-based panel, the method comprising:
providing a gypsum-based panel with a gypsum matrix; and
bending the panel in a first direction to crack the gypsum matrix.
